(19) United States
(12) Patent Application Publication
(10) Pub. No.: US 2022/0343212 A1
(43) Pub. Date: Oct. 27, 2022

(54) FORWARD COMPATIBLE MODEL TRAINING

(71) Applicant: NEC CORPORATION, Tokyo (JP)

(72) Inventors: Vivek BARSOPIA, Tokyo (JP); Yoshio KAMEDA, Tokyo (JP); Tomoya SAKAI, Tokyo (JP)

(21) Appl. No.: 17/389,237

(22) Filed: Jul. 29, 2021

Related U.S. Application Data
(60) Provisional application No. 63/177,355, filed on Apr. 20, 2021.

(51) Int. Cl. G06N 20/00

(52) U.S. Cl. CPC G06N 20/00; G06N 5/003

(57) ABSTRACT

Forward compatible models are obtained by operations including training a learning function with a current training data set to produce a first model, the current training data set including a plurality of samples, generating a plurality of prospective models, each prospective model based on a variation of one of the current training data set or the first model, adjusting a plurality of sample weights based on output of one or more prospective models among the plurality of prospective models in response to input of the current training data set, and retraining the learning function with the current training data set and the plurality of sample weights to produce a second model.

### CROSS-REFERENCE TO RELATED APPLICATIONS

This application claims the benefit of U.S. Provisional Patent Application Ser. No. 63/177,355, filed on Apr. 20, 2021, which is hereby incorporated by reference in its entirety.

### BACKGROUND

Machine learning models are used to make predictions. Such models are updated to improve or maintain the performance as the available information naturally increases and patterns deviate. When a model is updated, the new model may behave differently than the old model. Even in cases in which the new model is more accurate overall, the new model may introduce inaccuracies under certain circumstances in which the old model was accurate. The amount of such inaccuracies introduced by the new model is referred to as the Negative Flip Rate (NPR).

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of data flow for forward compatible model training, according to at least one embodiment of the present invention.

FIG. 2 is an operational flow for forward compatible model training, according to at least one embodiment of the present invention.

FIG. 3 is an operational flow for initializing sample weights, according to at least one embodiment of the present invention.

FIG. 4 is an operational flow for generating prospective models from prospective data sets, according to at least one embodiment of the present invention.

FIG. 5 is another operational flow for generating prospective models from model variation, according to at least one embodiment of the present invention.

FIG. 6 is an operational flow for adjusting sample weights, according to at least one embodiment of the present invention.

FIG. 7 is another operational flow for forward compatible model training, according to at least one embodiment of the present invention.

FIG. 8 is a block diagram of an exemplary hardware configuration for forward compatible model training, according to at least one embodiment of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

When a new model is inaccurate under circumstances in which the old model was accurate, users of the models must adapt to new shortcomings of the predictions, which will be frustrating to at least some users. On the other hand, at least some users of the models will welcome a new model to be accurate under circumstances in which the old model was inaccurate.

The NFR in updated models may be reduced by taking measures during training of the new model to make the new model backward-compatible with the old model. Techniques for making the new model backward-compatible include using sample weights during training to encourage the new model to be correct in response to input which resulted in correct output from the old model. Training the new model to be correct where the old model was correct avoids or reduces frustration in at least some users.

In at least some embodiments, measures are taken during training of the old model to make the old model forward-compatible with the new model. In at least some embodiments, forward-compatible training results in further decreased NFR in a future model, even when the future model does not undergo backward-compatible training.

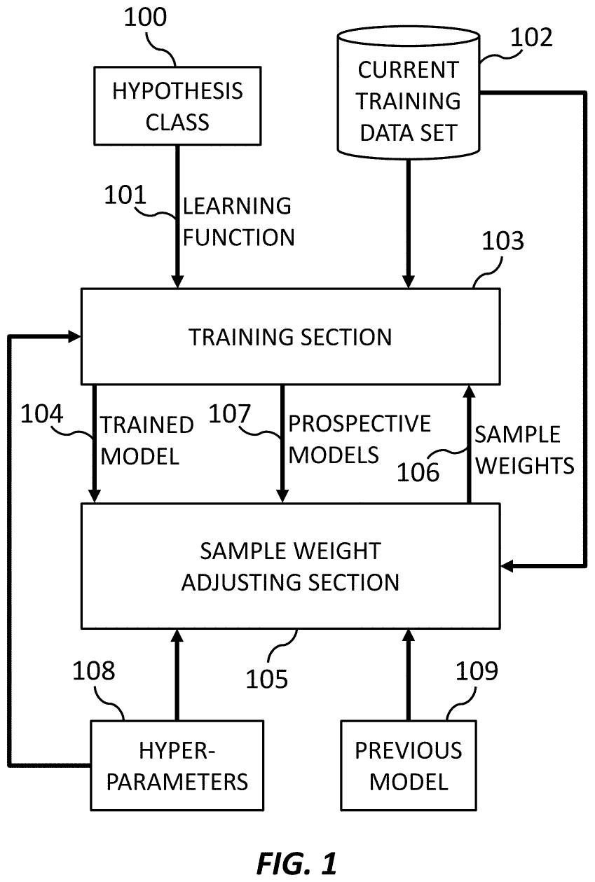

FIG. 1 is a schematic diagram of data flow for forward compatible model training, according to at least one embodiment of the present invention. The diagram includes hypothesis class 100, learning function 101, current training data set 102, training section 103, trained model 104, sample weight adjusting section 105, sample weights 106, hyper-parameters 108, and previous model 109.

Hypothesis class 100 is a class or group of learning functions for a given task. In at least some embodiments, interpretable hypothesis class 100 includes decision trees and linear classifiers.

Learning function 101 is one of a plurality of learning functions comprising interpretable hypothesis class 100. In at least some embodiments, learning function 101 is a neural network or other type of machine learning algorithm or approximate function. In at least some embodiments, learning function 101 includes weights having randomly assigned initial values between zero and one. In at least some embodiments, the learning function is one of a linear classifier and/or a decision tree.

Current training data set 102 is a data set including a plurality of samples. Each sample has a label indicating the correct result. In other words, when the sample is input into a model, the model should output the correct result indicated in the corresponding label. In at least some embodiments, current training data set 102 is prepared and curated in an effort to make current training data set 102 representative of an actual distribution.

Training section 103 is configured to train learning function 101 based on current training data set 102 to produce trained model 104. In at least some embodiments, training section 103 is configured to apply learning function 101 to current training data set 102, and to make adjustments to weights of learning function 101 based on the output of learning function 101 in response to input of current training data set 102. In at least some embodiments, training section 103 is configured to make adjustments to weights of learning function 101 further based on sample weights 106. In at least some embodiments, training section 103 is configured to perform multiple epochs of training to produce trained model 104 as a linear classification model or a decision tree. In at least some embodiments, training section 103 is configured to perform training to produce multiple iterations of trained model 104, each iteration of trained model 104 trained on a differently adjusted set of sample weights. In at least some embodiments, training section 103 is configured to apply learning function 101 to prospective training data sets to produce prospective models 107.

Sample weight adjusting section 105 is configured to assign sample weights to training data set 102 based on one or more of trained model 104, hyper-parameters 108, previous model 109, and prospective models 107. In at least some embodiments, sample weight adjusting section 105 adjusts a weight to a sample of training data 102 based on a correct output of one or more of previous model 109 and prospective models 107. In at least some embodiments, each sample weight among the plurality of sample weights 106 includes a forward-compatibility component and/or a backward-compatibility component. In at least some embodiments, each sample weight among the plurality of sample weights is a sum of the forward-compatibility component and the backward-compatibility component.

Hyper-parameters 108 include values that affect the adjustment of sample weights by sample weight adjusting section 105 or the training of learning function 101. In at least some embodiments, hyper-parameters 108 include a hyper-parameter that affects the relative significance of forward-compatibility and backward-compatibility during training. In at least some embodiments, one of the forward-compatibility component and the backward-compatibility component of each sample weight among the plurality of sample weights is multiplied by a relative significance factor. In at least some embodiments, hyper-parameters 108 include a learning coefficient, a number of prospective models, etc. Various other hyper-parameters are described below with respect to certain embodiments, any of which are included in hyper-parameters 108 at least in some embodiments.

Previous model 109 is trained from learning function 101 using a previous training data set. In at least some embodiments, previous model 109 is applied to current training data set 102 by sample weight adjusting section 105 to determine an appropriate sample weight set for backward compatibility.

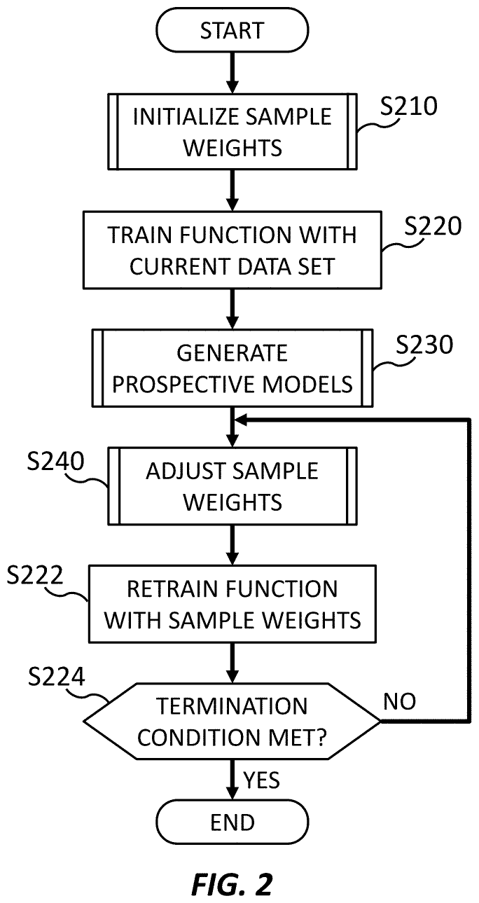

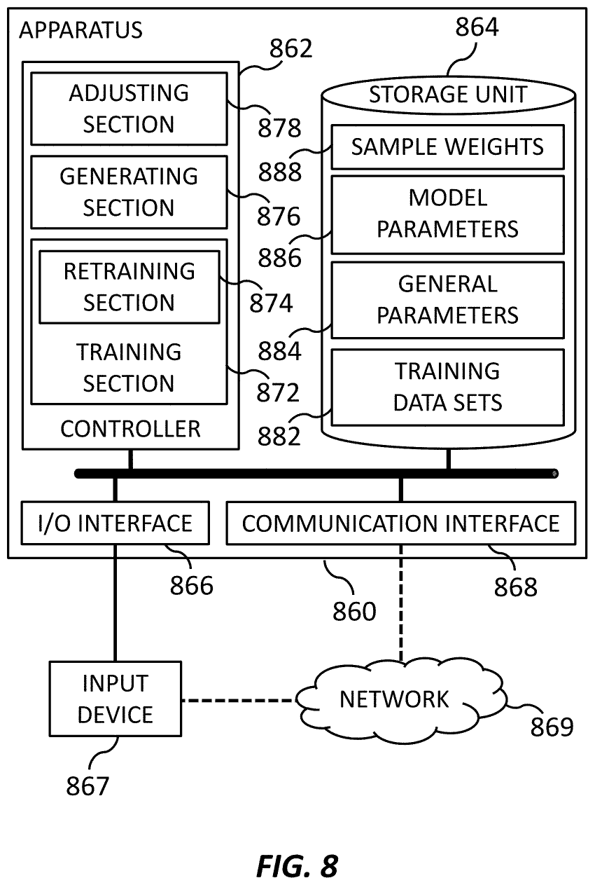

FIG. 2 is an operational flow for forward compatible model training, according to at least one embodiment of the present invention. The operational provides a method of forward compatible model training. In at least some embodiments, the method is performed by a controller of an apparatus including sections for performing certain operations, such as the controller and apparatus shown in FIG. 8, which will be explained hereinafter.

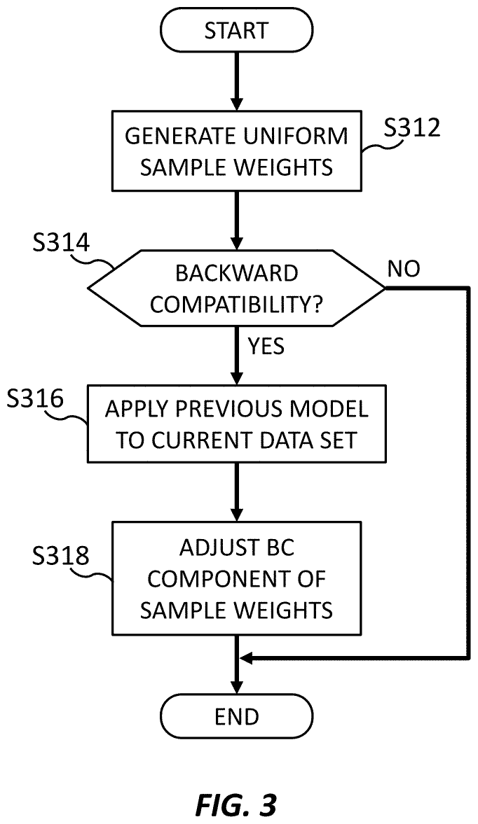

At S210, an adjusting section or a sub-section thereof initializes sample weights of a current training data set. In at least some embodiments, the adjusting section initializes a sample weight corresponding to each sample in the current training data set. In at least some embodiments, the adjusting section initializes, before the training of the learning function at S220, the plurality of sample weights such that the backward-compatibility components of the plurality of sample weights is based on output of the previous model in response to input of the current training data set, and the forward-compatibility components of the plurality of sample weights are uniform. In at least some embodiments, the initialization of sample weights proceeds as shown in FIG. 3, which will be explained hereinafter.

At S220, a training section or a sub-section thereof trains a learning function with the current training data set. In at least some embodiments, the training section trains a learning function with a current training data set to produce a first model, the current training data set including a plurality of samples. In at least some embodiments, the training section trains the learning function by Empirical Risk Minimization (ERM). In at least some embodiments, the training section trains the learning function by minimizing the loss function:

$$\hat{h} = arg {min}_{θ} \sum ℓ ( {h}_{θ} ( {x}_{i} ) , {y}_{i} ) , \qquad EQ . 1$$

where ĥ is the trained model, [symbol] is the loss function, h₀ is the learning function, xᵢ is the sample from the training data set, h₀(xᵢ) is the output from the learning function, and yᵢ is the correct output according to the training data set. In at least some embodiments, the training section trains the learning function with the plurality of sample weights initialized at S210 with backward-compatibility components. In at least some embodiments, the training section trains the learning function using the sample weights in the loss function:

$$\hat{h} = arg {min}_{θ} {max}_{ω ∈ W} \sum {ω}_{i} * ℓ ( {h}_{θ} ( {x}_{i} ) , {y}_{i} ) , \qquad EQ . 2$$

where ωᵢ is the sample weight corresponding to the sample xᵢ, and W is a sample weight set including all sample weights ωᵢ.

At S230, a generating section or a sub-section thereof generates a plurality of prospective models. In at least some embodiments, the generating section generates a plurality of prospective models, each prospective model based on a variation of one of the current training data set or the first model. In at least some embodiments, the generating section generates the plurality of prospective models from the model trained at S220. In at least some embodiments, the generating section generates the plurality of prospective models from the current training data set.

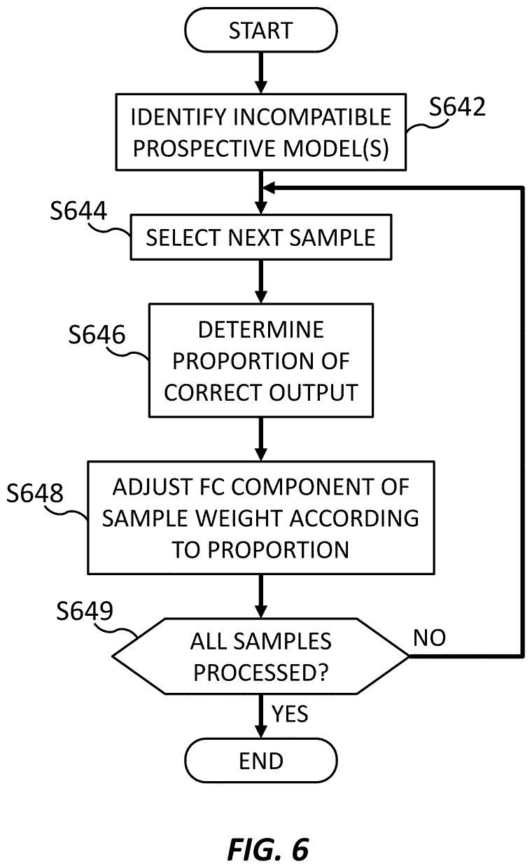

At S240, the adjusting section or a sub-section thereof adjusts the sample weights of the current training data set. In at least some embodiments, the adjusting section adjusts a plurality of sample weights based on output of one or more prospective models among the plurality of prospective models in response to input of the current training data set. In at least some embodiments, the adjusting section adjusts each sample weight based on whether prospective models output correctly in response to input from the current training data set. In at least some embodiments, the adjustment of sample weights proceeds as shown in FIG. 6, which will be explained hereinafter.

At S222, a retraining section retrains the learning function using the sample weights as adjusted at S240. In at least some embodiments, the retraining section retrains the learning function with the current training data set and the plurality of sample weights to produce a second model. In at least some embodiments, the retraining section retrains the learning function using the sample weights in the loss function:

$$\hat{h} = arg {min}_{h ∈ ℋ} \sum ( 1 + {α}_{i} ) * {( {y}_{i} - h ( {x}_{i} ) )}^{2} , \qquad EQ . 3$$

where αᵢ is the sample weight corresponding to the sample xᵢ, and [symbol] is a hypothesis class including all learning functions h. In each iteration of S222, the retraining section retrains the learning function using a differently adjusted sample weight set.

At S224, the controller or a section thereof determines whether a termination condition is met. In at least some embodiments, the termination condition is a number of iterations of the operations at S240 and S222. In at least some embodiments, the termination condition is a threshold NFR of the model retrained in the latest iteration of the retraining at S222. If the controller determines that the termination condition is not met, then the operational flow returns to the sample weight adjustment at S240 for another iteration. If the controller determines that the termination condition is met, then the operational flow ends.

FIG. 3 is an operational flow for initializing sample weights, according to at least one embodiment of the present invention. The operational flow provides a method of initializing sample weights. In at least some embodiments, the method is performed by an adjusting section, such as sample weight adjusting section 105 in FIG. 1, or correspondingly named sub-sections thereof.

At S312, the adjusting section or a sub-section thereof generates uniform sample weights. In at least some embodiments, the adjusting section generates all of the sample weights to be zero, one, or any other value that is uniform for all of the sample weights.

At S314, the adjusting section or a sub-section thereof determines whether to apply backward compatibility. In at least some embodiments, the adjusting section determines whether to apply backward compatibility based on whether or not a previous model exists, because backward compatibility requires an existing model to provide basis for backward compatibility. If the adjusting section determines to apply backward compatibility, then the operational flow proceeds to previous model application at S316. If the adjusting section determines not to apply backward compatibility, then the operational flow ends, maintaining uniformly initialized sample weights.

At S316, the adjusting section applies the previous model to the current raining data set. In at least some embodiments, the adjusting section applies the previous model to each sample in the current training data set, and records the output for future reference.

At S318, the adjusting section adjusts backward-compatibility components of the sample weights. In at least some embodiments, each sample weight has a backward-compatibility component and a forward-compatibility component. In at least some embodiments, each sample weight is equal to a sum total of the backward-compatibility component and the forward-compatibility component. In at least some embodiments, one of the backward-compatibility component and the forward-compatibility component is multiplied by a relative significance factor.

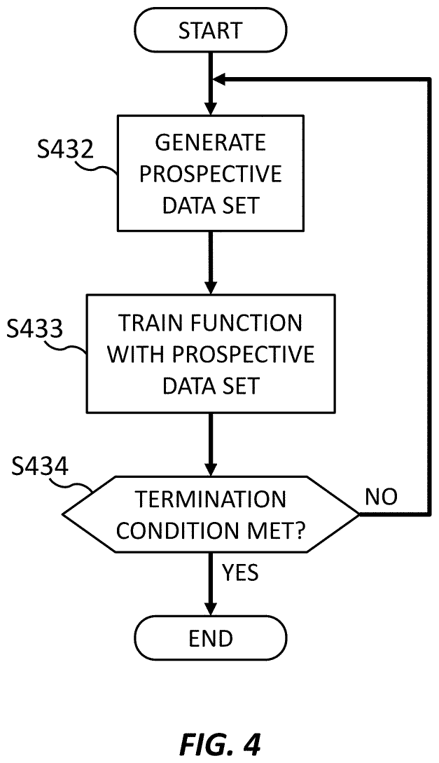

FIG. 4 is an operational flow for generating prospective models from prospective data sets, according to at least one embodiment of the present invention. The operational flow provides a method of generating prospective models from prospective data sets. In at least some embodiments, the method is performed by a generating section or correspondingly named sub-sections thereof. In at least some embodiments, the generating section is a sub-section of an adjusting section, such as sample weight adjusting section 105 in FIG. 1.

At S432, the generating section or sub-section thereof generates a prospective data set. In at least some embodiments, the generating section generates a prospective data set from the current training data set. In at least some embodiments, the generating section randomly changes the current training data set by oversampling, subsampling, etc. In at least some embodiments, the generating section uses a technique for generating prospective data sets based on the application of the model. In at least some embodiments, the generating section generates a prospective data set by changing the training data according to a perturbation vector. In at least some embodiments, as iterations of S432 proceed, the generating section generates a plurality of prospective training data sets based on a variation of the current training data set.

At S433, the generating section or a sub-section thereof trains a learning function with the prospective data set generated at S433 to produce a prospective model. In at least some embodiments, the generating section causes a training section, such as training section 103 in FIG. 1, to train the learning function. In at least some embodiments, the generating section trains the learning function by ERM. In at least some embodiments, the generating section trains the learning function in a substantially similar manner to training the learning function at S220, shown in FIG. 2, but using the prospective data set instead of the current training data set. In at least some embodiments, the generating section trains the learning function further using sample weights initialized for backward compatibility by applying the previous model to the prospective data set generated at S433. In at least some embodiments, as iterations of S433 proceed, the generating section trains the learning function with each prospective training data set among the plurality of prospective training data sets to produce a corresponding prospective model among the plurality of prospective models.

At S434, the generating section or a sub-section thereof determines whether a termination condition is met. In at least some embodiments, the termination condition is a number of iterations of the operations at S432 and S433. If the generating section determines that the termination condition is not met, then the operational flow returns to the prospective data set generation at S432. for another iteration. If the generating section determines that the termination condition is met, then the operational flow ends.

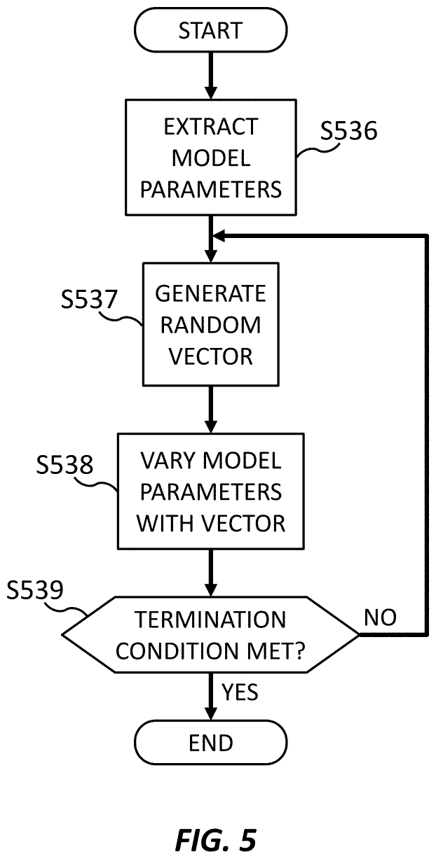

FIG. 5 is another operational flow for generating prospective models from model variation, according to at least one embodiment of the present invention. The operational flow provides a method of generating prospective models from model variation. In at least some embodiments, the method is performed by a generating section or correspondingly named sub-sections thereof. In at least some embodiments, the generating section is a sub-section of an adjusting section, such as sample weight adjusting section 105 in FIG. 1.

At S536, the generating section or a sub-section thereof extracts parameters from a model trained using the current training data set. In at least some embodiments, the generating section extracts parameters from the model trained at S220, shown in in FIG. 2. In at least some embodiments, generating section extracts parameters θ from the model trained by minimizing the loss function in EQ. 1.

At S537, the generating section or a sub-section thereof generates a random vector for varying parameters of the model. In at least some embodiments, the generating section generates a random vector for varying parameters of the first model. In at least some embodiments, the generating section generates a random vector L As iterations of S537 proceed, the generating section generates a plurality of random vectors.

At S538, the generating section or a sub-section thereof varies the parameters of the model based on the vector generated at S537. In at least some embodiments, the generating section varies the parameters of the first model based on the random vector to produce the plurality of prospective models, in at least some embodiments, the generating section varies the parameters θ based on the random vector ε. In at least some embodiments, the generating section adds the random vector ε to the parameters θ to generate a perturb model θ_{ε}. As iterations of S538 proceed, the generating section generates a plurality of prospective models, each prospective model among the plurality of prospective models corresponds to a unique variation of the parameters of the first model.

At S539, the generating section or a sub-section thereof determines whether a termination condition is met. In at least some embodiments, the termination condition is a number of iterations of the operations at S537 and S538. If the generating section determines that the termination condition is not met, then the operational flow returns to the random vector generation at S537 for another iteration. If the generating section determines that the termination condition is met, then the operational flow ends.

FIG. 6 is an operational flow for adjusting sample weights, according to at least one embodiment of the present invention. The operational flow provides a method of adjusting sample weights. In at least some embodiments, the method is performed by an adjusting section, such as sample weight adjusting section 105 in FIG. 1.

At S642, the adjusting section or a sub-section thereof identifies one or more incompatible models among a plurality of prospective models. In at least some embodiments, the adjusting section identifies one or more most incompatible models among the models generated at S230, shown in FIG. 2. In at least some embodiments, the adjusting section identifies an NFR for each prospective model compared with a model trained with the current training data set. In at least some embodiments, the adjusting section compares output of the first model with output of each prospective model among the plurality of prospective models in response to input of the current training data set. In at least some embodiments, the adjusting section compares the output of a prospective model and the model trained at S220, shown in FIG. 2, in response to input of a sample of the current training data set. In at least some embodiments, if the prospective model has correct put, and the model trained at S220 has incorrect output, then a negative flip is tallied. Once all negative flips have been tallied for each prospective model, the prospective models associated with more negative flips are identified by the adjusting section to be more incompatible, according to at least some embodiments. In at least some embodiments, the one or more prospective models identified among the plurality of prospective models have a highest negative flip rate with respect o the first model. In at least some embodiments, the adjusting section identifies the most incompatible model by according to the following brute force function:

$$, = arg {min}_{{h}_{ω} ∈ ℍ} NFR ( h 1 , {h}_{ω} , D 1 ) , \qquad EQ . 4$$

where h1 is the model trained using the unweighted current training data set, [symbol] is the plurality of prospective models, [symbol] is the most incompatible model, and [symbol] is the sample weight set corresponding to the most incompatible model. In at least some embodiments, as the adjusting the plurality of sample weights at S240 and the retraining the learning function at S222, shown in FIG. 2, are performed for a plurality of iterations, the adjusting the plurality of sample weights at S240 in each subsequent iteration includes comparing output of the second model retrained at S222 in a previous iteration with output of each prospective model among the plurality of prospective models in response to input of the current training data set to identify the one or more incompatible models among the plurality of prospective models.

At S644, the adjusting section or a sub-section thereof selects the next sample in the current training data set. The adjusting section selects the first sample in the first iteration of S644. As iterations of S644 proceed, all of the samples in the current training date set are selected for processing.

At S646, the adjusting section or a sub-section thereof determines a proportion of the incompatible models having correct output for the sample selected at S644. In at least some embodiments, the adjusting section determines a number of prospective models, among the one or more prospective models, with correct output in response to input of a corresponding sample in the training data set. In at least some embodiments, the adjusting section determines which incompatible models have correct output, and then divide that umber by the total number of incompatible models determined at S642. In at least some embodiments where only one incompatible model is determined at S642, the proportion determined by the adjusting section will be either one in response to the incompatible model being correct, or zero in response to the incompatible model being incorrect.

At S648, the adjusting section or a sub-section thereof adjusts a forward-compatibility component of the sample weight corresponding to the sample selected at S644 based on the proportion determined at S646. In at least some embodiments, the adjusting section sets the forward-compatibility components of the plurality of sample weights. In at least some embodiments, the adjusting section sets the sample weight in proportion to the number of prospective models. In at least some embodiments, the adjusting section further manipulates the proportion determined at S646 in adjusting the sample weight, such as by transposition or magnification.

At S649, the adjusting section or a sub-section thereof determines whether all of the samples in the current training data set have been processed. If the adjusting section determines that there are remaining unprocessed samples, then the operational flow returns to next sample selection at S644 for another iteration. If the adjusting section determines that all samples have been processed, then the operational flow ends.

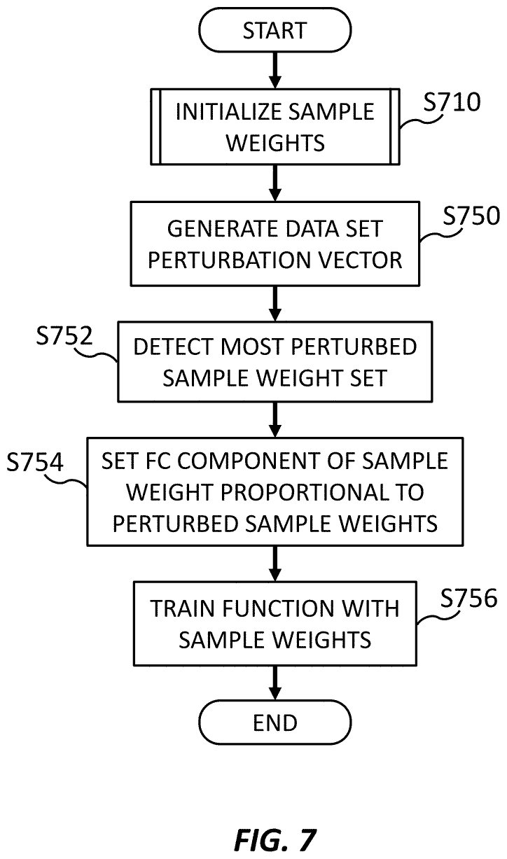

FIG. 7 is another operational flow for forward compatible model training, according to at least one embodiment of the present invention. The operational flow provides another method of forward compatible model training, In at least some embodiments, the method is performed by a controller of an apparatus including sections for performing certain operations, such as the controller and apparatus shown in FIG. 8, which will be explained hereinafter.

At S710, an adjusting section or a sub-section thereof initializes sample weights of a current training data set. In at least some embodiments, the adjusting section initializes a sample weight corresponding to each sample in the current training data set. In at least some embodiments, the initialization of sample weights proceeds as shown in FIG. 3.

At S750, a generating section or a sub-section thereof generates a perturbation vector for the current training data set. In at least some embodiments, the generating section derives the perturbation vector from multiple sample weight sets, such as the sample weight sets from multiple iterations of the sample weight adjustment at S240, shown in FIG. 2.

At S752, an adjusting section or a sub-section thereof detects a most perturbed sample weight set from the perturbation vector generated at S750. In at least some embodiments, the adjusting section detects the most perturbed sample weight set by applying a model trained using the current training data set, similar to the learning function training at S220, shown in FIG. 2, to the current training data set using the perturbation vector.

At S754, the adjusting section or a sub-section thereof sets a forward-compatibility component of each sample weight in proportion to the corresponding perturbed sample weight from the most perturbed sample weight set. In at least some embodiments, the adjusting section further manipulates each sample weight, such as by transposition or magnification.

At S756, a training section or a sub-section thereof trains a learning function using the current training data set with the sample weights adjusted at S754. In at least some embodiments, the training section trains the learning function using the sample weights in the loss function:

$${h}_{ro} = arg {min}_{θ} {max}_{ω ∈ 𝕎} \sum {ω}_{i} * loss ( h ( {x}_{i} ; θ ) , {y}_{i} ) \qquad EQ . 5$$

$$s . t . 𝕎 = \{ ω \vert ϕ ( ω , u ) < δ \} ,$$

where ϕ(ω,μ) is the Kullback-Leibler divergence between the unweighted current training data set μ and the weighted current training data set ω, and [symbol] represents all possible sample weight sets according to a perturbation vector limited by δ.

FIG. 8 is a block diagram of an exemplary hardware configuration for forward compatible model training, according to at least one embodiment of the present invention.

The exemplary hardware configuration includes apparatus 860, which communicates with network 869, and interacts with input device 867. Apparatus 860 may be a computer or other computing device that receives input or commands from input device 867. Apparatus 860 may be a host server that connects directly to input device 867, or indirectly through network 869. In some embodiments, apparatus 860 is a computer system that includes two or more computers. In some embodiments, apparatus 860 is a personal computer that executes an application for a user of apparatus 860.

Apparatus 860 includes a controller 862, a storage unit 864, a communication interface 868, and an input/output interface 866. In some embodiments, controller 862 includes a processor or programmable circuitry executing instructions to cause the processor or programmable circuitry to perform operations according to the instructions. In some embodiments, controller 862 includes analog or digital programmable circuitry, or any combination thereof. In some embodiments, controller 862 includes physically separated storage or circuitry that interacts through communication. In some embodiments, storage unit 864 includes a non-volatile computer-readable medium capable of storing executable and non-executable data for access by controller 862 during execution of the instructions. Communication interface 868 transmits and receives data from network 869. input/output interface 866 connects to various input and output units via a parallel port, a serial port, a keyboard poll, a mouse port, a monitor port, and the like to accept commands and present information.

Controller 862 includes training section 872, which includes retraining section 874, generating section 876, and adjusting section 875. Storage unit 864 includes training data sets 882, general parameters 884, model parameters 886, and sample weights 888.

Training section 872 is the circuitry or instructions of controller 862 configured to train learning functions. In at least some embodiments, training section 872 is configured to train learning functions, such as learning function 101 in FIG. 1, to produce models, such as trained model 104 and prospective models 107 in FIG. 1. In at least some embodiments, training section 872 utilizes information in storage unit 864, such as training data sets 882, loss functions and hyper-parameters included in general parameters 884, learning functions and trained models included in model parameters 886, and sample weights 888. In at least some embodiments, training section 872 includes sub-sections for performing additional functions, as described in the foregoing flow charts. In at least some embodiments, such sub-sections nay be referred to by a name associated with their function, such as retraining section 873.

Retraining section 874 is the circuitry or instructions of controller 862 configured to retrain learning functions based on sample weights. In at least some embodiments, retraining section 874 is configured to retrain learning functions, such as learning function 101 in FIG. 1, to produce trained models, such as trained model 104 in FIG. 1, etc. In at least some embodiments, retraining section 874 utilizes information in storage unit 864, such as training data 882, loss functions and hyper-parameters included in general parameters 884, learning functions and trained models included in model parameters 886 and sample weights 888. In at least some embodiments, retraining section 874 includes sub-sections for performing additional functions, as described in the foregoing flow charts. In at least some embodiments, such sub-sections may be referred to by a name associated with their function.

Generating section 876 is the circuitry or instructions of controller 862 configured to generate prospective models. In at least some embodiments, generating section 876 is configured to generate prospective models from prospective data sets, such as in FIG. 4, from model parameter variation, such as in FIG. 5, etc. In at least some embodiments, generating section 876 utilizes information in storage unit 864, such as hyper-parameters included in general parameters 884, trained models included in model parameters 886, and sample weights 888. In at least some embodiments, generating section 876 includes sub-sections for performing additional functions, as described in the foregoing flow charts. In at least some embodiments, such sub-sections may be referred to by a name associated with their function.

Adjusting section 878 is the circuitry or instructions of controller 862 configured to adjust sample weights. In at least some embodiments, adjusting section 878 is configured to adjust sample weights to training data sets 882 based on a trained model and one or more prospective models included in model parameters 886 and hyper-parameters included in general parameters 884. In at least some embodiments, adjusting section 878 records values in sample weights 888. In at least some embodiments, adjusting section 878 includes sub-sections for performing additional functions, as described in the foregoing flow charts. In at least some embodiments, such sub-sections are referred to by a name associated with the corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computes-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

Various embodiments of the present invention are described with reference to flowcharts and block diagrams whose blocks may represent (1) steps of processes in which operations are performed or (2) sections of a controller responsible for performing operations. Certain steps and sections are implemented by dedicated circuitry, programmable circuitry supplied with computer-readable instructions stored on computer-readable media, and/or processors supplied with computer-readable instructions stored on computer-readable media. In some embodiments, dedicated circuitry includes digital and/or analog hardware circuits and may include integrated circuits (IC) and/or discrete circuits. In some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Various embodiments of the present invention include a system, a method, and/or a computer program product. In some embodiments, the computer program product includes a computer readable storage medium (or media) having computer readable program instructions thereon for causing a processor to carry out aspects of the present invention.

In some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein are downloadable to respective computing/processing devices from a computer readable storage medium or to an external computer or external storage device via a network, for example, the Internet, a local area network, a wide, area network and/or a wireless network. In some embodiments, the network may includes copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium thin the respective computing/processing device.

In some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in combination of one or more programming languages, including an object oriented programming language such as Smalltalk, C++ or the like, and conventional procedural programming languages, such as the “C” programming language or similar programming languages. In some embodiments, the computer readable program instructions are executed entirely on the user's computer, partly on the user's computer, as a stand-alone software package, partly on the user's computer and partly on a remote computer or entirely on the remote computer or server. In some embodiments, in the latter scenario, the remote computer is connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above described embodiments. It will be apparent to persons skilled in the art that various alterations and improvements can be added to the above-described embodiments. It will also be apparent from the scope of the claims that the embodiments added with such alterations or improvements are included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the processes must be performed in this order.

According to at least one embodiment of the present invention, forward compatible models are obtained by operations including training a learning function with a current training data set to produce a first model, the current training data set including a plurality of samples, generating a plurality of prospective models, each prospective model based on a variation of one of the current training data set or the first model, adjusting a plurality of sample weights based on output of one or more prospective models among the plurality of prospective models in response to input of the current training data set, and retraining the learning function with the current training data set and the plurality of sample weights to produce a second model.

Some embodiments include the instructions in a computer program, the method performed by the processor executing the instructions of the computer program, and an apparatus that performs the method. In some embodiments, the apparatus includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is clamed is:

1. A computer-readable medium including instructions executable by a computer to cause the computer to perform operations comprising:
training a learning function with a current training data set to produce a first model, the current training data set including a plurality of samples;
generating a plurality of prospective models, each prospective model of the plurality of prospective models is based on a variation of one of the current training data set or the first model;
adjusting a plurality of sample weights based on an output of one or more prospective models among the plurality of prospective models in response to input of the current training data set; and
retraining the learning function with the current training data set and the plurality of sample weights to produce a second model

2. The computer-readable medium of claim 1, wherein the generating the plurality of prospective models includes:
generating a plurality of prospective training data sets based on a variation of the current training data set, and
training the learning function with each prospective training data set among the plurality of prospective training data sets to produce a corresponding prospective model among the plurality of prospective models.

3. The computer-readable medium of claim 1, wherein the generating the plurality of prospective models includes:
generating a random vector for varying parameters of the first model, and
varying the parameters of the first model based on the random vector to produce the plurality of prospective models,
wherein each prospective model among the plurality of prospective models corresponds to a unique variation of the parameters of the first model.

4. The computer-readable medium of claim 1, wherein the adjusting the plurality of sample weights includes:
comparing an output of the first model with an output of each prospective model among the plurality of prospective models in response to input of the current training data set,
wherein the one or more prospective models among the plurality of prospective models have a highest negative flip rate with respect to the first model.

5. The computer-readable medium of claim 4, wherein the adjusting the plurality of sample weights further includes, for each sample weight among the plurality of sample weights,
determining a number of prospective models among the one or more prospective models with a correct output in response to input of a corresponding sample in the current training data set, and
setting the sample weight in proportion to the number of prospective models.

6. The computer-readable medium of claim 5,
wherein the adjusting the plurality of sample weights and the retraining the learning function are performed for a plurality of iterations; and
wherein the adjusting the plurality of sample weights in each subsequent iteration includes comparing an output of the second model retrained in a previous iteration with an output of each prospective model among the plurality of prospective models in response to input of the current training data set.

7. The computer-readable medium of claim 1, wherein each sample weight among the plurality of sample weights includes a forward-compatibility component and a backward-compatibility component.

8. The computer-readable medium of claim 7, further comprising:
applying a previous model to the current training data set,
initializing, before the training of the learning function, the plurality of sample weights such that
the backward-compatibility components of the plurality of sample weights is based on an output of the previous model in response to input of the current training data set, and
the forward-compatibility components of the plurality of sample weights are uniform,
wherein the training the learning function is further with the plurality of sample weights, and
wherein the adjusting the plurality of sample weights includes setting the forward-compatibility components of the plurality of sample weights.

9. The computer-readable medium of claim 8, wherein the setting the forward-compatibility components of the plurality of sample weights further includes:
comparing an output of the first model with an output of each prospective model among the plurality of prospective models in response to input of the current training data set,
wherein the one or more prospective models among the plurality of prospective models have a highest negative flip rate with respect to the first model.

10. The computer-readable medium of claim 9, wherein the setting the forward-compatibility components of the plurality of sample weights further includes, for each sample weight among the plurality of sample weights,
determining a number of prospective models among the one or more prospective models with a correct output in response to input of a corresponding sample in the training data set, and
setting the forward-compatibility component in proportion to the number of prospective models.

11. The computer-readable medium of claim 7,
wherein each sample weight among the plurality of sample weights includes a sum of the forward-compatibility component and the backward-compatibility component, and
wherein one of the forward-compatibility component or the backward-compatibility component of each sample weight among the plurality of sample weights is multiplied by a relative significance factor.

12. The computer-readable medium of claim 1, wherein the learning function includes one of a linear classifier or a decision tree.

13. A method comprising:
training a learning function with a current training data set to produce a first model, the current training data set including a plurality of samples;
generating a plurality of prospective models, each prospective model of the plurality of prospective models is based on a variation of one of the current training data set or the first model;
adjusting a plurality of sample weights based on an output of one or more prospective models among the plurality of prospective models in response to input of the current training data set; and
retraining the learning function with the current training data set and the plurality of sample weights to produce a second model.

14. The method of claim 13, wherein the generating the plurality of prospective models includes:
generating a plurality of prospective training data sets based on a variation of the current training data set, and
training the learning function with each prospective training data set among the plurality of prospective training data sets to produce a corresponding prospective model among the plurality of prospective models.

15. The method of claim 13, wherein the generating the plurality of prospective models includes:
generating a random vector for varying parameters of the first model, and
varying the parameters of the first model based on the random vector to produce the plurality of prospective models,
wherein each prospective model among the plurality of prospective models corresponds to a unique variation of the parameters of the first model.

16. The method of claim 13, wherein the adjusting the plurality of sample weights includes:
comparing an output of the first model with an output of each prospective model among the plurality of prospective models in response to input of the current training data set,
wherein the one or more prospective models among the plurality of prospective models have a highest negative flip rate with respect to the first model.

17. The method of claim 16, wherein the adjusting the plurality of sample weights further includes, for each sample weight among the plurality of sample weights,
determining a number of prospective models, among the one or more prospective models, with a correct output in response to input of a corresponding sample in the current training data set, and
setting the sample weight in proportion to the number of prospective models.

18. The method of claim 17,
wherein the adjusting the plurality of sample weights and the retraining the learning function are performed for a plurality of iterations; and
wherein the adjusting the plurality of sample weights in each subsequent iteration includes comparing an output of the second model retrained in a previous iteration with an output of each prospective model among the plurality of prospective models in response to input of the current training data set.

19. The method of claim 13, wherein each sample weight among the plurality of sample weights includes a forward-compatibility component and a backward-compatibility component.

20. A computer-readable medium including instructions executable by a computer to cause the computer to perform operations comprising:
generating a perturbation vector for varying parameters of a current training data set;
detecting a most perturbed sample weight set from the perturbation vector, the most perturbed sample weight set including a sample weight corresponding to each sample in the current training data set;
adjusting a plurality of sample weights based on the most perturbed sample weight set; and
training the learning function with the current training data set and the plurality of sample weights to produce a second model.
